(19) United States
(12) Patent Application Publication
(10) Pub. No.: US 2015/0275453 A1
(43) Pub. Date: Oct. 1, 2015

(54) MULTI-PURPOSE FLOATING DEBRIS SKIMMER

(71) Applicant: David Skadeland, Port Wentworth, GA (US)

(72) Inventor: David Skadeland, Port Wentworth, GA (US)

(21) Appl. No.: 14/669,388

(22) Filed: Mar. 26, 2015

Related U.S. Application Data
(60) Provisional application No. 61/970,555, filed on Mar. 26, 2014.

(51) Int. Cl. E02B 15/10; C02F 1/40

(52) U.S. Cl. CPC E02B 15/10; C02F 1/40

(57) ABSTRACT

A debris skimmer includes an entry section including an opening through which debris is directed, an angled plane in the entry section that extends from a high point adjacent the opening to a low point, and a storage section disposed downstream of the entry section. The debris skimmer separates the debris from water or other fluid, enabling it to be captured and removed.

### CROSS-REFERENCES TO RELATED APPLICATIONS

This application claims the benefit of U.S. Provisional Patent Application No. 61/970,555, filed Mar. 26, 2014, the entire content of which is herein incorporated by reference.

### STATEMENT REGARDING FEDERALLY SPONSORED RESEARCH OR DEVELOPMENT

(Not Applicable)

### BACKGROUND OF THE INVENTION

The invention relates to a debris skimmer and, more particularly, to a debris skimmer that can separate floating debris and floating liquid from a body of water without moving parts or electrical power.

It is desirable to clear debris from bodies of water to sustain and improve conservation of oceans, seas, rivers, lakes, ponds and wildlife and to provide improved safety to marine life and humans. Such debris may include floating oil, fuel, plants, plastics or trash or other floating liquid or solid debris. Existing debris skimmers are generally difficult to operate, expensive and require high maintenance. Existing designs typically require multiple passes to capture the debris and are generally inefficient particularly when collecting liquid debris. Additionally, existing debris skimmers are typically less effective in rough seas or where multiple debris types are present. In rough water, existing designs take in too much water, thereby further reducing efficiency.

### BRIEF SUMMARY OF THE INVENTION

The debris skimmer according to preferred embodiments can be pulled, pushed or remain stationary in a flowing current. As water flows through the device, debris enters the opening and is contained by two vertical side walls extending below the surface of the water. The flowing force of the water against the floating debris forces the debris down an angled plane, under a vertical divider wall and into a storage section. The collected debris floats to the top of the storage section and can be readily removed. In expanded embodiments, a static vacuum may be created in the storage section, and the debris can be collected in an attached storage tank. The skimmer may also be suitably configured as an oil spill recovery system.

In an exemplary embodiment, a debris skimmer includes an entry section including an opening through which debris is directed, an angled plane in the entry section that extends from a high point adjacent the opening to a low point, and a storage section disposed downstream of the entry section.

In another exemplary embodiment, a debris skimmer includes a pair of upstanding side walls having a bottom and a top and defining a skimmer working zone. A divider wall extends between the side walls and divides the skimmer working zone into an entry section and a storage section. A bottom end of the divider wall terminates between the bottom and the top of the side walls. An angled plane disposed in the entry section extends from a high point adjacent an opening of the entry section to a low point adjacent the bottom end of the divider wall.

In yet another exemplary embodiment, a method of skimming debris from a body of water with a debris skimmer includes the steps of (a) partially submerging the debris skimmer in the body of water; (b) ensuring movement of water from the body of water relative to the debris skimmer; (c) directing the debris to the entry section; (d) deflecting the water and the debris deeper in the water with the angled plane; and (e) capturing the debris in the storage section after the debris passes the angled plane.

### BRIEF DESCRIPTION OF THE DRAWINGS

These and other aspects and advantages will be described in detail with reference to the accompanying drawings, in which:

FIG. 1 is a perspective view of an exemplary debris skimmer construction according to the described embodiments;

FIG. 2 shows the debris skimmer of FIG. 1 including an attached storage tank;

FIGS. 3 and 4 show the debris skimmer in use; and

FIGS. 5 and 6 show an application of the debris skimmer as an oil spill recovery system.

### DETAILED DESCRIPTION OF THE INVENTION

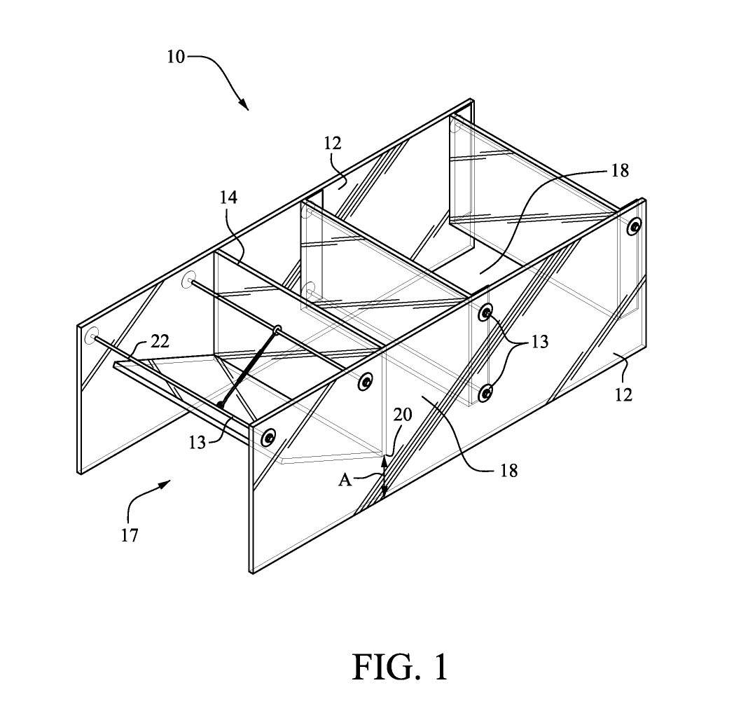

With reference to FIG. 1, the debris skimmer 10 according to preferred embodiments includes a pair of upstanding sidewalls 12, each having a bottom and a top and defining a skimmer working zone. A divider wall 14 extends between the sidewalls 12 and divides the skimmer working zone into an entry section 16 and a storage section 18. The entry section 16 includes an opening 17 through which debris is directed. The sidewalls 12 are connected by suitable connectors 13 across a width of the skimmer 10 or through the divider walls 14. As shown in FIG. 1, a bottom end 20 of the divider wall 14 terminates between the bottom and the top of the sidewalls 12. In FIG. 1, the bottom 20 of the divider wall 14 is spaced a distance A from the bottom of the sidewalls 12. Additional divider walls may also be extended between the sidewalls 12 for structural integrity, to add storage capacity, and to expand the debris capture area (discussed in more detail below).

An angled plane 22, such as an inclined wall or an equivalent, is disposed in the entry section 16. The angled plane 22 is adjustable and inclined to extend from a high point adjacent the opening 17 of the entry section 16 to a low point adjacent the bottom end 20 of the divider wall 14. The degree of incline of the angled plane 22 can be adjusted by displacing the angled plane 22 about a pivot adjacent the bottom end 20 of the divider wall 14.

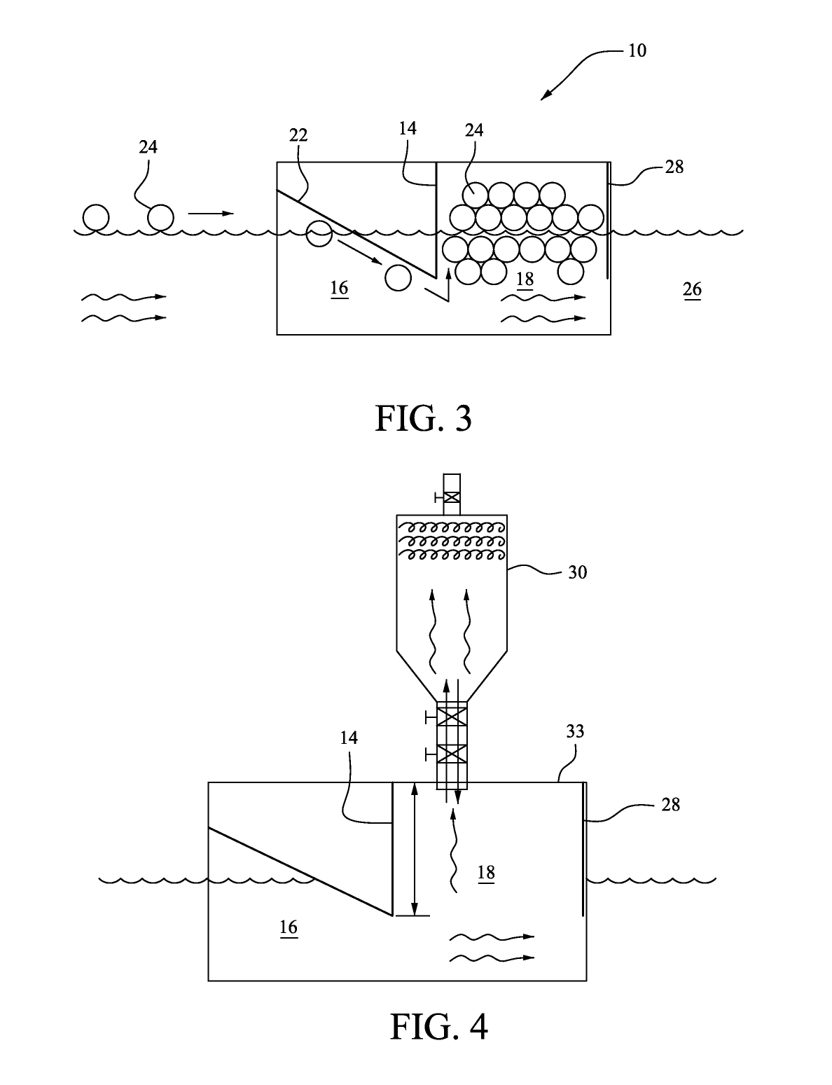

FIG. 3 shows an exemplary application of the debris skimmer for skimming loose debris 24 floating on the surface of a body of water 26. As shown in FIG. 3, the debris skimmer 10 is partially submerged in the body of water 26. The debris skimmer 10 operates by movement or current of water relative to the debris skimmer. The debris skimmer 10 can be pulled, pushed or remain stationary in a flowing current. The position of the skimmer 10 in the water 26 can be controlled by positioning floats or the like so that the skimmer 10 is maintained in the water 26 in a suitable position. In use, the skimmer 10 should be positioned such that the high point of the angled plane 22 is out of the water while its low point is submerged in the water.

As water flows through the skimmer 10, the debris 24 is directed to the entry section 16, and the debris is contained by the sidewalls 12. The relative flow of water against the debris 24 forces the debris down the angled plane 22, under the divider wall 14 and into the storage section 18. The water continues to flow through the skimmer 10 and out a back wall 28, which also terminates between the bottom and top of the sidewalls 12. Preferably, a bottom of the back wall 28 is spaced from a bottom of the sidewalls 12 in amount generally similar to the space A between the bottom 20 of the divider wall 14 and the bottom of the sidewalls 12. After passing under the divider wall 14, the floating debris rises to the top of the water surface in the storage section 18. In the embodiment shown in FIGS. 1 and 3, the volume of debris is limited to the area from the bottom of the angled plane 22/divider wall 14 to the level of the water in the skimmer 10, which is determined by the height of flotation. The debris can subsequently be pumped out by standard means into containers, storage units, ship storage holds, etc.

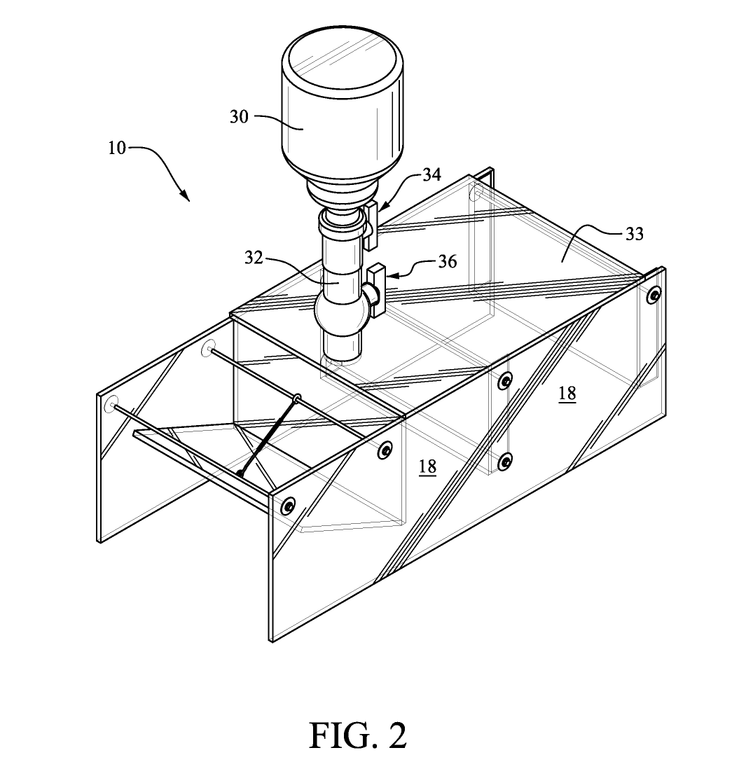

In order to expand functionality and capacity of the debris skimmer, a vacuum pump may be provided with an inlet disposed in the storage section 18. The vacuum pump may be a powered pump or alternatively may be a static vacuum in fluid communication with the storage section 18. FIG. 2 shows an exemplary embodiment where a storage tank 30 is in fluid communication with the storage section 18 of the skimmer 10 via a suitable pipe 32 secured in a top wall 33. The top wall 33 seals the storage section 18. The pipe 32 includes a storage tank cutoff valve 34 and a storage section cutoff valve 36 arranged in series between the storage section 18 and the storage tank 30. The storage tank 30 may be filled with water and inverted as shown in FIG. 2. With the valves 34 and 36 open, water in the storage tank 30 flows through the pipe 32 to the storage section 18. The water leaving the pipe 32 draws air into the pipe filling the space left by the displaced water from the tank 30 until the water in the storage section 18 reaches the pipe 32, thereby creating the static vacuum. If there is not enough water in the tank 30 to fill the storage section 18, the valves can be closed, and another storage tank 30 can be attached.

In one embodiment, a second pipe between the storage tank and the storage section may facilitate flow of water and air and debris when in use.

In use, with reference to FIG. 4, the skimmer 10 with storage tank 30 can be utilized to collect liquid such as oil or the like floating on the surface of the body of water 26. The debris 24 as floating liquid is directed into the entry section 16 and deflected deeper into the water with the angled plane 22. As the debris passes under the divider wall 14, the debris is captured by the static vacuum and flows up the pipe 32 to the bottom (top) of the inverted storage tank 30. The static vacuum is maintained as long as the water level in the storage section 18 is up to the pipe 32 opening in the storage section 18. When the tank 30 is full of debris, the valves 34, 36 can be closed, and the tank 30 can be replaced and/or emptied or the like. Of course, as an alternative to the tank, a piping system may be used to generate the static vacuum and deliver the debris to a holding tank on a barge or the like.

An optional screen may be placed under the collection tank to prevent solid debris from rising with liquid debris in the tank. With a static vacuum, there is no suction and therefore the screen does not clog.

FIGS. 1 and 2 show an extra storage section 18 downstream of the first storage section. The second storage section serves to expand the storage capacity of the skimmer. Additionally, the extra storage section may be desirable if the relative speed of the water flow is too high to capture all of the debris in the first storage section. Rather than floating up into the first storage section, the debris may flow under the storage section back wall without being captured if the relative speed of the skimmer is too high. The extra storage section helps to prevent this from happening.

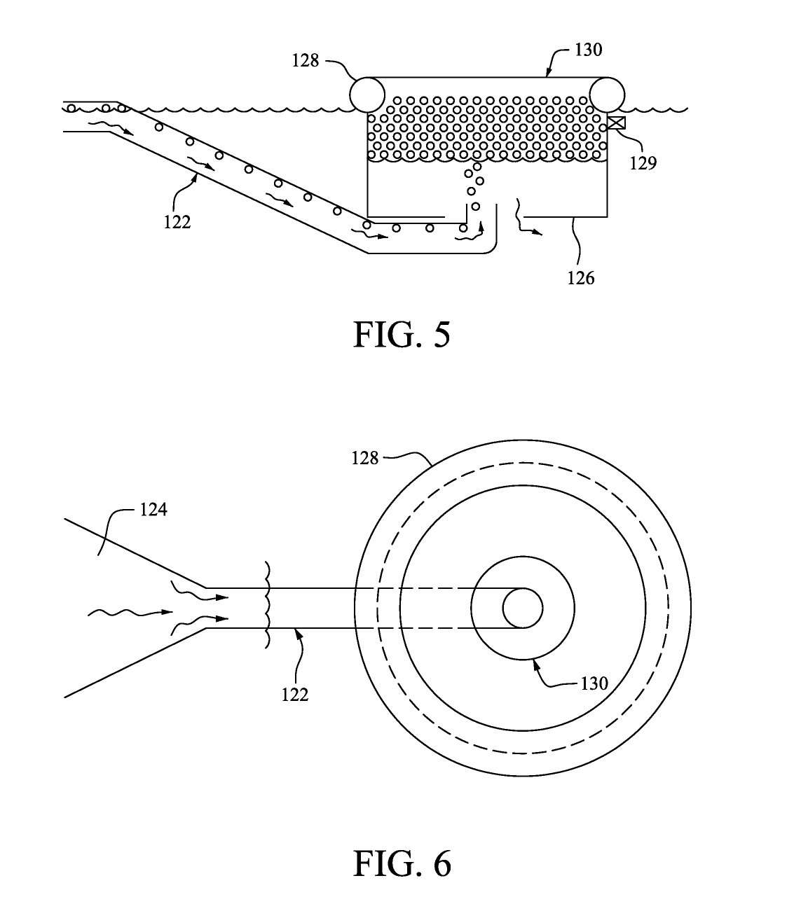

FIGS. 5 and 6 show an application of the debris skimmer for oil spill recovery. In this embodiment, the angled plane is a tube 122. Oil or other floating liquid is directed into the tube 122 by a boom 124 or the like, and the relative current causes the liquid debris to flow down the tube 122 deeper into the water. A recovery tank 130 having an open bottom and top is positioned in fluid communication with a downstream end of the pipe 122. As the liquid debris exits the pipe 122, the liquid debris flows through a deflecting skirt 126 and floats into the tank 130, which is partially submerged, so that the liquid debris floats on top of the water inside the tank 130. The tank may be inflatable or may include a flotation device 128 to facilitate positioning of the tank and the tube 122 relative to the water line. As the recovered liquid debris floats to the top of the tank 130, water in the tank is displaced and flows out the bottom. Recovery vehicles or the like can connect to pump out ports 129 to recover the contained debris.

In use, the system may be connected to a ship or rigged by cables. Outriggers may be used to spread booms that widen a capture area and direct the liquid debris to the tube. The deflecting skirt 126 may divert the oil that is forced to the bottom by outside wave pressure by deflecting it back toward the center of the tank where it can rise again. The system may also include a current deflector (not shown) that covers an area from the bottom to the top of each side of the tank and extends to a transfer pipe adapter that decreases drag on the tank.

The debris skimmer concept has multiple applications in addition to the exemplary applications described above. For example, the concept may be applicable to remove excess grease and oils during cooking. With a smaller-scale version of the debris skimmer, a household skimmer may include a crank or the like enabling the user to rotate a suitably sized member positioned below the liquid surface. Rotation of the member causes the relative displacement of the liquid to the device so that an inclined surface can direct the oil to a storage section. The debris skimmer separates the debris from water or other fluid, enabling it to be captured and removed.

While the invention has been described in connection with what is presently considered to be the most practical and preferred embodiments, it is to be understood that the invention is not to be limited to the disclosed embodiments, but on the contrary, is intended to cover various modifications and equivalent arrangements included within the spirit and scope of the appended claims.

1. A debris skimmer, comprising:
an entry section including an opening through which debris is directed;
an angled plane in the entry section, the angled plane extending from a high point adjacent the opening to a low point; and
a storage section disposed downstream of the entry section.

2. A debris skimmer according to claim 1, wherein the entry section and the storage section are defined by side walls and a dividing wall, and wherein a depth of the side walls is greater than a depth of the dividing wall.

3. A debris skimmer according to claim 2, wherein the side walls extend below the low point of the angled plane.

4. A debris skimmer according to claim 2, wherein the angled plane extends from the high point adjacent the opening to the low point adjacent a bottom end of the dividing wall.

5. A debris skimmer according to claim 2, wherein a degree of incline of the angled plane is adjustable.

6. A debris skimmer according to claim 5, wherein the angled plane is pivotable around a bottom end of the dividing wall.

7. A debris skimmer according to claim 1, wherein a degree of incline of the angled plane is adjustable.

8. A debris skimmer according to claim 1, further comprising a vacuum pump having an inlet disposed in the storage section.

9. A debris skimmer according to claim 1, further comprising a static vacuum in fluid communication with the storage section.

10. A debris skimmer according to claim 9, wherein the static vacuum comprises a storage tank coupled with the storage section.

11. A debris skimmer according to claim 10, further comprising a storage tank cutoff valve and a storage section cutoff valve arranged in series between the storage section and the storage tank.

12. A debris skimmer according to claim 10, wherein the storage tank is filled with water and inverted.

13. A debris skimmer according to claim 1, wherein the angled plane is a tube.

14. A debris skimmer according to claim 13, wherein the storage section comprises an inflatable tank with an open top and an open bottom, and wherein an exit end of the tube is disposed adjacent the open bottom.

15. A debris skimmer, comprising:
a pair of upstanding side walls having a bottom and a top and defining a skimmer working zone;
a divider wall extending between the side walls and dividing the skimmer working zone into an entry section and a storage section, wherein a bottom end of the divider wall terminates between the bottom and the top of the side walls; and
an angled plane disposed in the entry section, the angled plane extending from a high point adjacent an opening of the entry section to a low point adjacent the bottom end of the divider wall.

16. A method of skimming debris from a body of water with a debris skimmer including an entry section with an opening through which debris is directed, an angled plane in the entry section, and a storage section disposed downstream of the entry section, the method comprising:
(a) partially submerging the debris skimmer in the body of water;
(b) ensuring movement of water from the body of water relative to the debris skimmer;
(c) directing the debris to the entry section;
(d) deflecting the water and the debris deeper in the water with the angled plane; and
(e) capturing the debris in the storage section after the debris passes the angled plane.

17. A method according to claim 16, wherein step (b) is practiced by holding the debris skimmer steady in a current.

18. A method according to claim 16, wherein step (b) is practiced by displacing the debris skimmer relative to the water.

19. A method according to claim 16, further comprising establishing a static vacuum on the storage section, and drawing the debris into a storage tank attached to the storage section with the static vacuum.

20. A method according to claim 16, further comprising adjusting an angle of the angled plane according to one of a type of the debris and a speed of the water relative to the debris skimmer.
